(19) United States
(12) Patent Application Publication
(10) Pub. No.: US 2007/0023387 A1
(43) Pub. Date: Feb. 1, 2007

(54) PRINTED CIRCUIT BOARD INTERCONNECTION AND METHOD

(75) Inventor: Thomas D. Murry, Springfield, MO (US)

Correspondence Address: MARSTELLER & ASSOCIATES, P.C., PO BOX 803302, DALLAS, TX, 75380-3302, US

(73) Assignee: Litton Systems, Inc., Los Angeles, CA (US)

(21) Appl. No.: 11/164,388

(22) Filed: Nov. 21, 2005

Related U.S. Application Data
(60) Provisional application No. 60/595,695, filed on Jul. 28, 2005.

(51) Int. Cl. H01B 13/00

(52) U.S. Cl. 216/13

(57) ABSTRACT

A product of and method for laminating and interconnecting multiple layer printed circuit boards (14) includes at least two complementary substrates (10 and 12) each having a solder bump (30) formed from conductive material (28) applied to a desired component (22). A dam network (34) is formed about the bumps (30) to prevent undesired spreading of the conductive material (28). Bonding material (36) between the surfaces (38a and 38b) of the substrates (10 and 12) bonds the multiple layers. The bonding material (36) has apertures through which the solder bumps (30) are connected.

### CROSS REFERENCE TO RELATED APPLICATIONS

This application claims the benefit of U.S. Provisional Application Ser. No. 60/595,697, filed Jul. 28, 2005, entitled PRINTED CIRCUIT BOARD INTERCONNECTION AND METHOD.

### BACKGROUND OF THE INVENTION

1. Technical Field

The invention relates to the field of wiring boards for electronic devices, and more particularly to methods for laminating multiple large-layer-count substrates with reliable mechanical and electrical connections.

2. Background Art

Multilayer substrates potentially offer the advantages of more efficient use of space in a circuit board design, but require more complex connection capability and circuit modularity. Significant problems exist in aligning, laminating, drilling and plating multilayer substrates, particularly for large-layer-count (LLC) substrates and substrates with high densities of electronic components.

While multilayer substrates typically offer the advantage of more efficient use of space in a circuit board design, multilayer substrates typically require more complex connection capabilities and circuit modularity. These complexities give rise to several problems. For one, it generally is difficult to establish an electrical interconnection between components of separate substrates because solder used in establishing connections may spread or migrate to other components causing electrical shorts. As a result, the failure of a single connection may cause an entire multilayer package to be discarded as incurably defective.

Known methods of joining layers of a LLC have been taught in U.S. Pat. Nos. 5,786,238; 5,986,339; 6,742,247; and 6,856,008.

While eliminating some of the problems discussed above, these techniques have a number of limitations such as mentioned above. It also is to be appreciated that printed wiring boards (PWBs) with plated solder bumps typically are difficult to handle as solder slivers may also separate from the plated bumps and cause problems in subsequent manufacturing operations unless the boards are reflowed to melt and secure the bumps.

Therefore, there is a need in the art for an improved process of interconnecting two or more independent substrates.

While the above cited references introduce and disclose a number of noteworthy advances and technological improvements within the art, none completely fulfills the specific objectives achieved by this invention.

### SUMMARY OF INVENTION

The present invention permits the deposit and control of solder bumps used to establish electrical connections between various layers in a multi-layer printed circuit board.

In accordance with the present invention, a multi-layer printed circuit board or package includes a first multi-layer substrate layer that has a selected surface with electrical components for mating. The first substrate layer further includes conductive material formed into at least one first body or bump that is in electrical contact with the area selected for electrical interconnection on the first surface of the first multi-layer substrate. A dam network composed of a solder resist material is formed on the desired surface of the first multi-layer substrate to minimize undesired spreading of the conductive material of the first body.

A second multi-layer substrate layer having a second surface complementary to the selected first surface of the first substrate layer similarly includes conductive material formed into at least one second body or bump that is in electrical contact with the area selected for electrical interconnection on the surface of the second multi-layer substrate. A dam network composed of a solder resist material is formed on the desired surface of the second multi-layer substrate to minimize undesired spreading of the conductive material of the second body.

A bonding material or film is disposed between a first selected surface of the first multi-layer substrate and the second complementary surface of the second multi-layer substrate. The bonding material has at least one aperture formed substantially located between the first conductive material body and the complementary second conductive material body. An electrical connection is formed between the first conductive material body and the second conductive material body establishing the electrical interface between the substrates without an electrical short being formed by excess conductive material being squeezed into contact with an adjoining electrical component such as a via.

These and other objects, advantages and preferred features of this invention will be apparent from the following description taken with reference to the accompanying drawings, wherein is shown the preferred embodiments of the invention.

### BRIEF DESCRIPTION OF DRAWINGS

A more particular description of the invention briefly summarized above is available from the exemplary embodiments illustrated in the drawings and discussed in further detail below. Through this reference, it can be seen how the above cited features, as well as others that will become apparent, are obtained and can be understood in detail. The drawings nevertheless illustrate only typical, preferred embodiments of the invention and are not to be considered limiting of its scope as the invention may admit to other equally effective embodiments.

FIG. 1 is a cross section of a printed circuit board with sub-laminations and vias.

FIG. 2 is a cross section of the printed circuit board of FIG. 1 with an organic stencil applied.

FIG. 3 is a cross section of the printed circuit board of FIG. 2 with wells defined in the stencil for solder paste.

FIG. 4 is a cross section of the printed circuit board of FIG. 3 with the wells filled with solder paste.

FIG. 5 is a cross section of the printed circuit board of FIG. 4 with the solder paste fused.

FIG. 6 is a cross section of the printed circuit board of FIG. 5 after the organic stencil is removed.

FIG. 7 is a cross section of the printed circuit board of FIG. 6 with a solder resist gasket applied, developed and cured.

FIG. 8 is an overhead view of the printed circuit board of the present invention.

FIG. 9 is a cross sectional view of the method of the present invention having been applied on a sub-lamination of a printed circuit board matching the circuit board of FIGS. 1 through 7.

FIG. 10 is a cross section view of a bonded printed circuit board of the present invention.

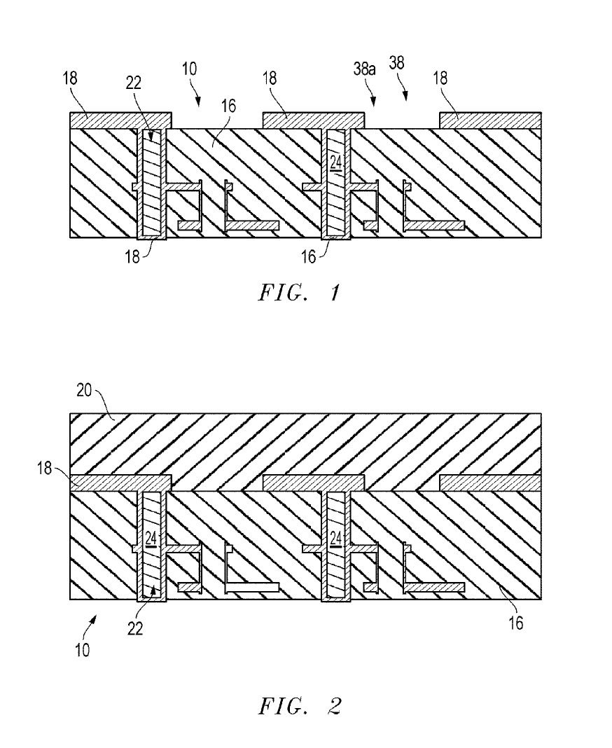

### DETAILED DESCRIPTION

So that the manner in which the above recited features, advantages, and objects of the present invention are attained can be understood in detail, more particular description of the invention, briefly summarized above, may be had by reference to the embodiment thereof that is illustrated in the appended drawings. In all the drawings, identical numbers represent the same elements.

For illustrative purposes, the interface between only two sub-assemblies or layers and 12 of a known type of multi-layer printed circuit board 14 will be demonstrated. Additional layers subject to being interfaced may be used.

The present process can work with multiple laminations since the disclosed capture method precludes electrical shorts.

A multi-layer printed circuit board or package 14 includes a first multi-layer substrate layer 10 that has a selected surface 38a with electrical components 22 for mating. The first substrate layer 10 further includes conductive material 28 formed into at least one first body or bump 30a that is in electrical contact with an area selected for electrical interconnection generally on the first surface 38a of the first multi-layer substrate 10. A dam network 34 composed of a solder resist material 32 is formed on the desired surface 38 of the first multi-layer substrate 10 to minimize undesired spreading of the conductive material 28 of the first body 30a during the application of the conductive material 28 or during a subsequent bonding step.

A second multi-layer substrate layer 12 having a second surface 38b complementary to the selected first surface 38a of the first substrate layer 10 similarly includes conductive material 28 formed into at least one second body or bump 30b that is in electrical contact with an area selected for electrical interconnection generally on the surface 38b of the second multi-layer substrate 12. A dam network 34 composed of a solder resist material 32 is similarly formed on the desired surface 38 of the second multi-layer substrate 12 to minimize undesired spreading of the conductive material 28 of the second body 30b during the application of the conductive material 28 or during the bonding of the first multi-layer substrate layer 10 with the second multi-layer substrate layer 12.

A known bonding material or film 36 for securing or bonding the first multi-layer substrate layer 10 with the second multi-layer substrate layer 12 is disposed between first selected surface 38a of the first multi-layer substrate 10 and the second complementary surface 38b of the second multi-layer substrate 12. The bonding material 36 has a pattern formed with at least one aperture 40 formed in a manner or patter such that the hole is substantially located between the first conductive material body 30a and the complementary second conductive material body 30b when the two substrate layer halves or portions are joined.

An electrical connection is formed between the first conductive material body 30a and the second conductive material body 30b establishing the electrical interface between the substrates without an electrical short being formed by excess conductive material 28 being squeezed into contact with an adjoining electrical component such as a via 22.

During the lamination or bonding phase, a pressure and temperature are selected to be sufficient to melt the solder or other chosen conductive material of the first and second bodies. This creates an intermingling of two fluids that during a “freezing” period of the solder becoming a single joined body or contact. Even so, there are some systems that may require only intimate contact or a pressure contact rather than a “melting” of the conductive material. Such a pressure contact implies that the conductive material would not reflow or become fluid, and therefore, would have a mashed or compression type contact. Such would include any polymer thick films or other non-reflowable materials to do the same thing. Solder has been used simply as an example because of its ease of use.

The first and second dam networks 34 cooperating with the first surface 38a of the first multi-layer substrate 10 and the second complementary surface 38b of the second multi-layer substrate 12 form a sealed void about the first and second conductive material bodies 30a and 30b, respectively, for preventing undesired flow or movement of the material composing the conductive bodies during bonding of the first and second multi-layer substrate layers.

An alternative embodiment of the present invention may utilize a single dam network that is associated with either the first multi-layer substrate layer 10 or the second multi-layer substrate layer 12 such that the dam network 34 cooperates with the first surface 38a of the first multi-layer substrate 10 and the second complementary surface 38b of the second multi-layer substrate 12 when the layers are bonded to form a sealed void about the first and second conductive material bodies 30a and 30b, respectively, for preventing undesired flow or movement of the material composing the conductive bodies during bonding of the first and second multi-layer substrate layers.

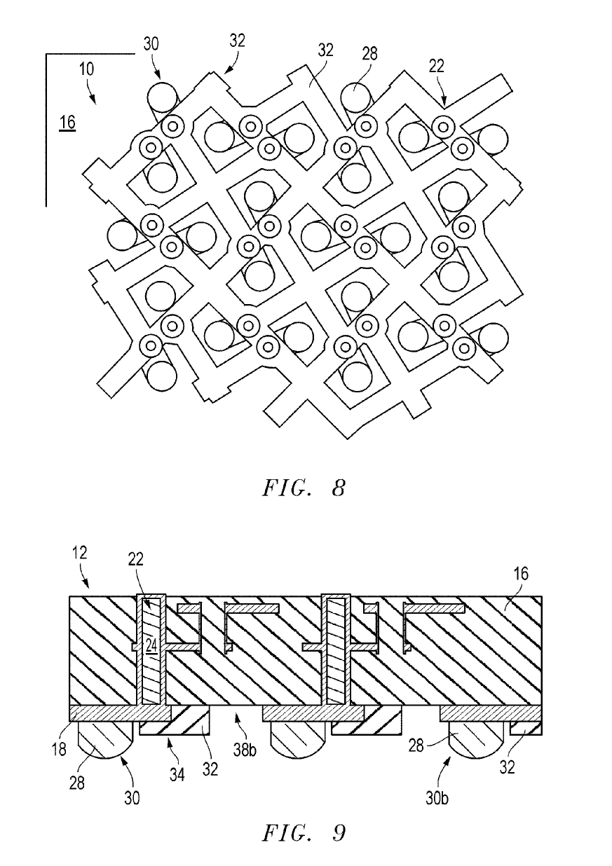

Use of a single dam network 34 would still require a mask of some sort on the second sub-assembly or layer to prevent solder bridging between copper connections associated with the second or complementary layer. An important issue with multilayer printed circuit boards 14 is density of interconnections per square inch (cm or whatever measurement unit is named). Solder generally will wick along a “solderable surface” to an area of low pressure. Low pressure in a lamination package generally occurs between two closely spaced copper features. Thus, use of a single dam network may require an image of some type on the second sub-lamination to control the flow. Nevertheless, it is believed that the embodiment depicted generally in FIG. 8 is preferred to be on both sub-laminations, but is required on one with a mask to prevent solder bridging between adjacent copper on the second layer.

Method of Manufacture

First, sub-laminations or printed circuit board layers 10 and 12 are to be completed through a known solder strip step or process. All surface solder should preferably be removed to allow for controlling the movement of solder on a selected surface 38 of the printed circuit board layer. It should also be understood that the sub-laminations can include, as is known in the art, filled or unfilled vias 22. To simplify the explanation of the present invention, the accompanying drawing figures show only vias 22 filled with an organic fill 24.

In FIG. 2, the top surface 38 of the product or layer 10 is coated with a known organic or inorganic first stencil material 20. The stencil 20 seals to printed circuit conductive material 18, such as copper, and to the surface of the laminate material 16, and precludes any un-wanted solder 28 movement. The first stencil 20 is configured to define wells or voids 26 in combination with the following step to give necessary solder paste 28 volume for the desired project or application.

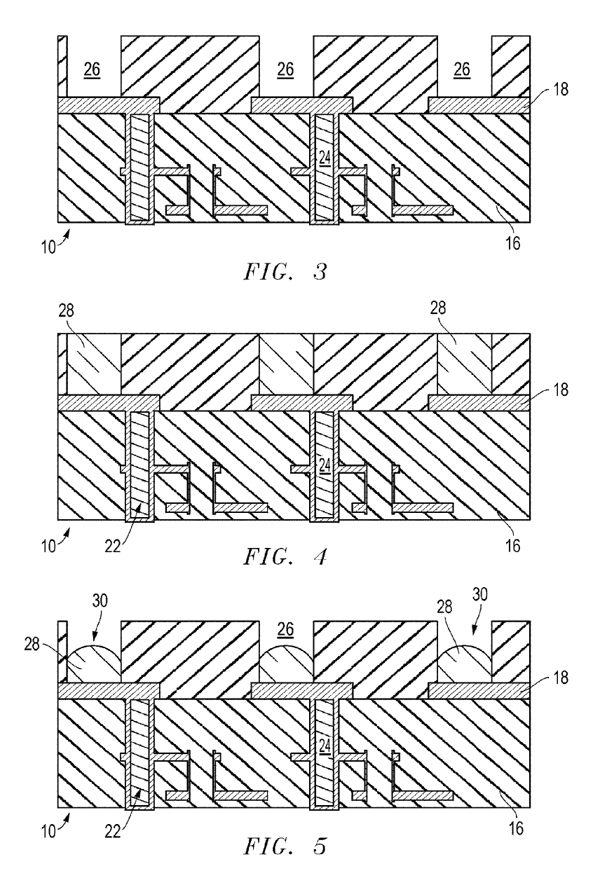

Any known suitable method may be used to create a cylindrical void 26 in the first stencil layer 20 for application of the solder paste 28. The method of forming the wells 26 may include, but is not limited to, drill, laser ablation, or photo-imaging. The chosen organic or inorganic stencil 20 is configured in combination with the above step to give necessary solder paste 28 volume for the specific project. See FIG. 3.

With reference to FIG. 4, the cylinder or well 26 is filled with a desired amount of a known conductive solder paste 28 suitable to establishing a connection between layers 10 and 12 of the multi-layer printed circuit board 14.

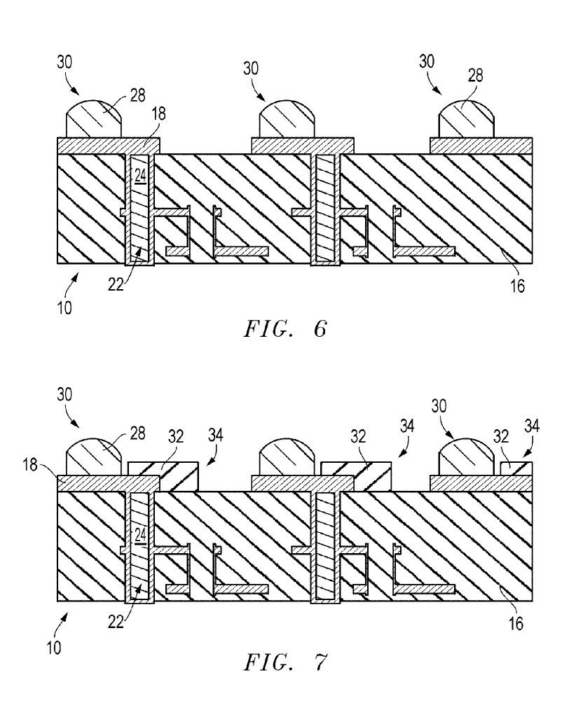

Next, the solder paste 28 is fused in accordance with the specifications for the solder paste to form a solder bump or body 30. See FIGS. 5 and 6.

Referring to FIG. 6, the remainder of the first stencil 20 is removed or stripped using an appropriate method for the system used. Once the first stencil material is removed, it should be noted that it is important that surface insulation resistance and ionic contamination left on the surface 38 should meet the requirements for the project. The printed circuit board system or layer 10 should be used accordingly.

In FIG. 7 a solder resist 32 is applied in a desired pattern to control undesired solder 28 movement mainly during the bonding step when the multi-layers are joined. This is a distinct pattern as is shown in the top view of FIG. 8 to create a gasket system or dam structure 34 having localized high and low-pressure or raised areas to control the movement or flow of the solder 28 during the joining of the multiple layers of the printed circuit board 14. The solder resist 32 that may be used in the present invention is any commercially available photo-imagable soldermask or other appropriate material. FIG. 7 shows the resist material 32 imaged, developed and cured.

The size or dimensions of the dam network 34 is preferably selected in order to permit the interconnection of the first and second bodies when the first and second substrate layers are mated or joined.

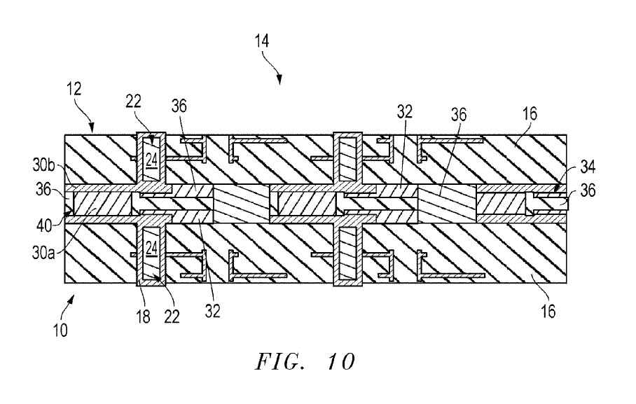

The above described sequence is then repeated or duplicated on a matching or complementary sub-lamination 12 for the assembly into the completed multi-layer or laminated printed circuit board 14. See FIG. 9.

The next step in forming the interfaced multi-layer printed circuit board 14 is bonding between the two ‘halves’ or layers 10 and 12 that is accomplished through a controlled lamination cycle using a known adhesive or low-flow prepreg material 36. The bonding material 36 has apertures 40 formed in it to allow for a body 28 on substrate layer to make contact with a complementary body 28 associated with substrate layer 12.

It is important that the gasket 34 formed from the solder resist material 32 pinches off available routes for the solder flow to take. The gasket or dam 34 directs any excess solder material, whether from over-pressure, thin bonding material, or excess solder paste to a safe ‘dump’ zone preventing any shorting issues between the various electrical components of the printed circuit board.

The foregoing disclosure and description of the invention are illustrative and explanatory thereof, and various changes in the size, shape and materials, as well as in the details of the illustrated construction may be made without departing from the spirit of the invention.

What is claimed is:

1. A multi-layer package comprising:
a first multi-layer substrate layer having a selected first surface with electrical components for mating including:
conductive material formed into at least one first body that is in electrical contact with an area selected for electrical interconnection of the first multi-layer substrate; and
a first dam network formed on the desired surface of the first multi-layer substrate for minimizing undesired spreading of the conductive material of the first body during bonding; and
a second multi-layer substrate layer having a second surface complementary to the selected first surface of the first substrate layer, the second multi-layer substrate layer including:
conductive material formed into at least one second body that is in electrical contact with an area selected for electrical interconnection of the second multi-layer substrate; and
a second dam network formed on the desired surface of the second multi-layer substrate to minimize undesired spreading of the conductive material of the second body during bonding of the first and second multi-layer substrate layers; and
an electrical connection formed between the first conductive material body and the second conductive material body when the first and second multi-layer are joined.

2. The invention of claim 1 further including bonding material disposed between first selected surface of the first multi-layer substrate and the second complementary surface of the second multi-layer substrate for joining the fist and second multi-layer substrate layers together; the bonding material having at least one aperture substantially located between the first conductive material body and the complementary second conductive material body when the substrate layers are bonded.

3. The invention of claim 1 wherein the first and second dam networks cooperating with the first surface of the first multi-layer substrate and the second complementary surface of the second multi-layer substrate form a sealed void about the first and second conductive material bodies for preventing undesired movement of the material composing the conductive bodies during bonding of the first and second multi-layer substrate layers.

4. The invention of claim 1 wherein at least one of the substrate layers is formed having at least one via.

5. The invention of claim 2 wherein the via is filled with an organic fill.

6. The invention of claim 1 wherein the conductive material comprises a solder paste.

7. The invention of claim 1 wherein the first and second conductive material bodies consist of fused solder paste.

8. The invention of claim 1 wherein the first and second conductive material bodies are interconnected during the bonding step using desired temperature and pressure to melt the conductive material forming the bodies.

9. The invention of claim 1 wherein the first and second conductive material bodies are interconnected during the bonding step with physical contact of the first and second bodies forming an electrical junction.

10. The invention of claim 1 wherein dam network is formed from a solder resist material.

11. The invention of claim 10 wherein solder resist material is a photo-imagable soldermask.

12. The invention of claim 1 wherein the bonding material between the substrate layers is an adhesive.

13. The invention of claim 1 wherein the bonding material between the substrate layers is a low-flow prepreg material.

14. A multi-layer package comprising:
a first multi-layer substrate layer having a selected first surface with electrical components for mating including a conductive material formed into at least one first body that is in electrical contact with an area selected for electrical interconnection of the first multi-layer substrate;
a second multi-layer substrate layer having a second surface complementary to the selected first surface of the first substrate layer, the second multi-layer substrate layer including a conductive material formed into at least one second body that is in electrical contact with an area selected for electrical interconnection of the second multi-layer substrate;
a dam network associated with a desired surface of at least one of the multi-layer substrate layers to minimize undesired spreading of the conductive material of the first and second bodies during bonding of the first and second multi-layer substrate layers; and
an electrical connection formed between the first conductive material body and the second conductive material body when the first and second multi-layer are joined.

15. The invention of claim 14 further including bonding material disposed between first selected surface of the first multi-layer substrate and the second complementary surface of the second multi-layer substrate for joining the fist and second multi-layer substrate layers together; the bonding material having at least one aperture substantially located between the first conductive material body and the complementary second conductive material body when the substrate layers are bonded.

16. The invention of claim 14 wherein the dam network cooperating with the first surface of the first multi-layer substrate and the second complementary surface of the second multi-layer substrate forms a sealed void about the first and second conductive material bodies for containing undesired movement of the material composing the conductive bodies during bonding of the first and second multi-layer substrate layers.

17. The invention of claim 14 wherein at least one of the substrate layers is formed having at least one via.

18. The invention of claim 15 wherein the via is filled with an organic fill.

19. The invention of claim 14 wherein the conductive material comprises a solder paste.

20. The invention of claim 14 wherein the first and second conductive material bodies consist of fused solder paste.

21. The invention of claim 14 wherein the first and second conductive material bodies are interconnected during the bonding step using desired temperature and pressure to melt the conductive material forming the bodies.

22. The invention of claim 14 wherein the first and second conductive material bodies are interconnected during the bonding step with physical contact of the first and second bodies forming an electrical junction.

23. The invention of claim 14 wherein dam network is formed from a solder resist material.

24. The invention of claim 23 wherein solder resist material is a photo-imagable soldermask.

25. The invention of claim 14 wherein the bonding material between the substrate layers is an adhesive.

26. The invention of claim 14 wherein the bonding material between the substrate layers is a low-flow prepreg material.

27. A method for electrically interconnecting at least a first substrate layer and a complementary second substrate layer formed into a multi-layer circuit board comprising the steps of:
preparing the first multi-layer substrate layer comprising the steps of:
applying a first stencil material to a desired surface of the first multi-layer substrate;
forming at least one void in the first stencil material exposing a portion of the desired surface of the first multi-layer substrate in an area of the first substrate layer selected for an electrical interconnection between the first and second multi-layer substrates;
applying a conductive material into a selected void to form the conductive material into a first body that is in electrical contact with the area selected for electrical interconnection on the surface of the first multi-layer substrate;
removing desired stencil material from the surface of the first multi-layer substrate;
forming a first dam network on the desired surface of the first multi-layer substrate about at least one first bodies of conductive material for minimizing undesired spreading of the conductive material of the first body during bonding; and
preparing the second complementary multi-layer substrate layer comprising the steps of:
applying a second stencil material to a desired complementary surface of the second multi-layer substrate;
forming at least one void in the second stencil material exposing a portion of the desired surface of the second multi-layer substrate in a complementary area of the second substrate layer selected for an electrical interconnection between the first and second multi-layer substrates;
applying a conductive material into a selected void in the second stencil material to form the conductive material into a second body that is in electrical contact with the area selected for electrical interconnection on the surface of the second multi-layer substrate;
removing desired second stencil material from the surface of the second multi-layer substrate;
forming a second dam network on the desired surface of the second multi-layer substrate about at least one second body of conductive material for minimizing undesired spreading of the conductive material of the second body during bonding; and
joining the first multi-layer substrate and the second multi-layer substrate together to form an electrically conductive connection between the first conductive material body and the complementary second conductive material body in at least a portion of the aperture in the bonding material.

28. The method of claim 27 further including the step of positioning bonding material between the desired surface of the first multi-layer substrate and the complementary surface of the second multi-layer substrate, the bonding material being formed having at least one aperture substantially located between the first conductive material body and the complementary second conductive material body when the substrate layers are joined.

29. The method of claim 27 wherein the first and second dam networks cooperating with the first surface of the first multi-layer substrate and the second complementary surface of the second multi-layer substrate form a sealed void about the first and second conductive material bodies for containing undesired movement of the material composing the conductive bodies during bonding of the first and second multi-layer substrate layers.

30. The method of claim 27 wherein at least one of the substrate layers is formed having at least one via.

31. The invention of claim 30 wherein the via is filled with an organic fill.

32. The method of claim 27 wherein the stencil material applied to the desired surface of the first multi-layer substrate is composed of an organic material.

33. The method of claim 27 wherein the stencil material applied to the desired surface of the first multi-layer substrate is composed of an inorganic material.

34. The method of claim 27 wherein the conductive material comprises a solder paste.

35. The method of claim 27 wherein the void in the stencil material is formed using a drilling technique.

36. The method of claim 27 wherein the void in the stencil material is formed using a laser ablation technique.

37. The method of claim 27 wherein the void in the stencil material is formed using a photo-imaging technique.

38. The method of claim 27 wherein the conductive material comprises a solder paste.

39. The method of claim 27 wherein the first and second conductive material bodies consist of fused solder paste.

40. The method of claim 27 wherein the first and second conductive material bodies are interconnected during the bonding step using desired temperature and pressure to melt the conductive material forming the bodies.

41. The method of claim 27 wherein the first and second conductive material bodies are interconnected during the bonding step with physical contact of the first and second bodies forming an electrical junction.

42. The method of claim 27 wherein the dam network is formed from a solder resist material.

43. The method of claim 42 wherein solder resist material is a photo-imagable soldermask.

44. The method of claim 27 wherein an adhesive joins the substrate layers.

45. The method of claim 27 wherein a low-flow prepreg material joins the substrate layers.

46. A method for electrically interconnecting at least a first substrate layer and a complementary second substrate layer formed into a multi-layer circuit board comprising the steps of:
preparing the first multi-layer substrate layer comprising the steps of:
applying a first stencil material to a desired surface of the first multi-layer substrate;
forming at least one void in the first stencil material exposing a portion of the desired surface of the first multi-layer substrate in an area of the first substrate layer selected for an electrical interconnection between the first and second multi-layer substrates;
applying a conductive material into a selected void to form the conductive material into a first body that is in electrical contact with the area selected for electrical interconnection on the surface of the first multi-layer substrate;
removing desired stencil material from the surface of the first multi-layer substrate;
preparing the second complementary multi-layer substrate layer comprising the steps of:
applying a second stencil material to a desired complementary surface of the second multi-layer substrate;
forming at least one void in the second stencil material exposing a portion of the desired surface of the second multi-layer substrate in a complementary area of the second substrate layer selected for an electrical interconnection between the first and second multi-layer substrates;
applying a conductive material into a selected void in the second stencil material to form the conductive material into a second body that is in electrical contact with the area selected for electrical interconnection on the surface of the second multi-layer substrate;
removing desired second stencil material from the surface of the second multi-layer substrate;
forming a dam network associated with a desired surface of at least one of the multi-layer substrate layers about at least one body of conductive material for minimizing undesired spreading of the conductive material of the first and second bodies during bonding; and
joining the first multi-layer substrate and the second multi-layer substrate together to form an electrically conductive connection between the first conductive material body and the complementary second conductive material body in at least a portion of the aperture in the bonding material.

47. The method of claim 46 further including the step of positioning bonding material between the desired surface of the first multi-layer substrate and the complementary surface of the second multi-layer substrate, the bonding material being formed having at least one aperture substantially located between the first conductive material body and the complementary second conductive material body when the substrate layers are joined.

48. The method of claim 46 wherein the dam network cooperating with the first surface of the first multi-layer substrate and the second complementary surface of the second multi-layer substrate forms a sealed void about the first and second conductive material bodies for containing undesired movement of the material composing the conductive bodies during bonding of the first and second multi-layer substrate layers.

49. The method of claim 46 wherein at least one of the substrate layers is formed having at least one via.

50. The invention of claim 49 wherein the via is filled with an organic fill.

51. The method of claim 46 wherein the stencil material applied to the desired surface of the first multi-layer substrate is composed of an organic material.

52. The method of claim 46 wherein the stencil material applied to the desired surface of the first multi-layer substrate is composed of an inorganic material.

53. The method of claim 46 wherein the conductive material comprises a solder paste.

54. The method of claim 46 wherein the void in the stencil material is formed using a drilling technique.

55. The method of claim 46 wherein the void in the stencil material is formed using a laser ablation technique.

56. The method of claim 46 wherein the void in the stencil material is formed using a photo-imaging technique.

57. The method of claim 46 wherein the conductive material comprises a solder paste.

58. The method of claim 46 wherein the first and second conductive material bodies consist of fused solder paste.

59. The method of claim 46 wherein the first and second conductive material bodies are interconnected during the bonding step using desired temperature and pressure to melt the conductive material forming the bodies.

60. The method of claim 46 wherein the first and second conductive material bodies are interconnected during the bonding step with physical contact of the first and second bodies forming an electrical junction.

61. The method of claim 46 wherein the dam network is formed from a solder resist material.

62. The method of claim 61 wherein solder resist material is a photo-imagable soldermask.

63. The method of claim 46 wherein an adhesive joins the substrate layers.

64. The method of claim 46 wherein a low-flow prepreg material joins the substrate layers.
